(19) United States
(12) Patent Application Publication
(10) Pub. No.: US 2011/0202580 A1
(43) Pub. Date: Aug. 18, 2011

(54) STORAGE EQUIPMENT

(76) Inventors: Toshihiro Kato, Tokyo (JP); Shimpei Usui, Yokohama (JP)

(21) Appl. No.: 13/125,358

(22) PCT Filed: Jan. 12, 2010
(86) PCT No.: PCT/JP2010/000111

§ 371 Date: Apr. 21, 2011

(30) Foreign Application Priority Data
Jan. 13, 2009 (JP) 2009-005127

(51) Int. Cl. G06F 17/30

(52) U.S. Cl. 707/822; 707/E17.01

(57) ABSTRACT

[Object] Portable-type storage equipment that by itself enables data control such as analysis of data recorded or to be recorded in recording media even under the environment where a host system such as a host PC does not exist.

[Solution] Storage equipment including a drive unit 2 for driving a recording medium 1, a signal processing unit 3 for sending or receiving a regeneration and/or recording signal to/from the recording medium, a first control unit 20A having a first arithmetic processing unit 58 for controlling the drive unit and the signal processing unit, and a second control unit 20B having a control memory 60 and a second arithmetic processing unit 64 is characterized in that the control memory includes an area for storing a file system for data analysis of the recording medium, an area for storing an application program which uses the data, and an area for storing management information used by the application program.

### TECHNICAL FIELD

The present invention relates to storage equipment such as an optical disc device. Particularly, the invention relates to portable-type storage equipment that can regenerate and/or record information on recording media and enable information analysis without the premise of the existence of a PC environment and that can be carried by a user or set at home.

### BACKGROUND ART

An optical disc device has been conventionally known as this type of storage equipment. An example of this optical disc device is disclosed as an optical disc device capable of realizing databases in a laptop computer in, for example, Japanese Patent Application Laid-Open (Kokai) Publication No. H06-187723. Furthermore, Japanese Patent Application Laid-Open (Kokai) Publication No. H07-141232 discloses an optical disc device capable of operating as a file storage device.

Conventionally, with portable-type storage equipment, a host PC controls an optical disc device as a peripheral, so that the optical disc device has been considered satisfactory because it receives a write command or a read command from the host PC, receives data from the host PC, and writes the data to an optical disc. The host PC has a file system, so it can update and analyze data recorded on an optical disc and record the updated data on the optical disc.

### CITATION LIST

### Patent Literature

[PTL 1] Japanese Patent Application Laid-Open (Kokai) Publication No. H06-187723
[PTL 2] Japanese Patent Application Laid-Open (Kokai) Publication No. H07-141232

### SUMMARY OF INVENTION

### Technical Problem

The conventional optical disc device by itself cannot analyze data recorded in a recording medium or data to be recorded under the environment where the host PC does not exist.

Therefore, it is an object of the present invention to provide portable-type storage equipment that by itself enables data control such as analysis of data recorded or to be recorded in recording media even under the environment where a host system such as a host PC does not exist.

### Solution to Problem

In order to solve the above-described problem, storage equipment including a drive unit for driving a recording medium, a signal processing unit for sending or receiving a regeneration and/or recording signal to/from the recording medium, a first control unit having a first arithmetic processing unit for controlling the drive unit and the signal processing unit, and a second control unit having a control memory and a second arithmetic processing unit is provided according to the present invention, which is characterized in that the control memory includes an area for storing a file system for data analysis of the recording medium, an area for storing an application program which uses the data, and an area for storing management information used by the application program.

### Advantageous Effects of Invention

Portable-type storage equipment that by itself can control data such as analysis of data recorded in recording media and data to be recorded therein even under the environment where a host PC does not exist can be provided according to the present invention as described above.

### BRIEF DESCRIPTION OF DRAWINGS

FIG. 1 is a block configuration diagram of an example of an optical disc device according to the present invention.

FIG. 2 is a block diagram of an example of a first control circuit and a second control circuit for the optical disc device in FIG. 1.

FIG. 3 is a block diagram showing the relationship between existing control executed by the first control circuit in the optical disc device and additional control executed by the second control circuit.

FIG. 4 is a block configuration diagram of a control memory for the second control circuit.

FIG. 5 is a first example of a user interface screen displayed on a (liquid crystal) display for the optical disc device.

FIG. 6 is a second example of the user interface screen.

FIG. 7 is a third example of the user interface screen.

FIG. 8 is a flowchart illustrating update processing executed by the second control circuit on a database.

### DESCRIPTION OF EMBODIMENTS

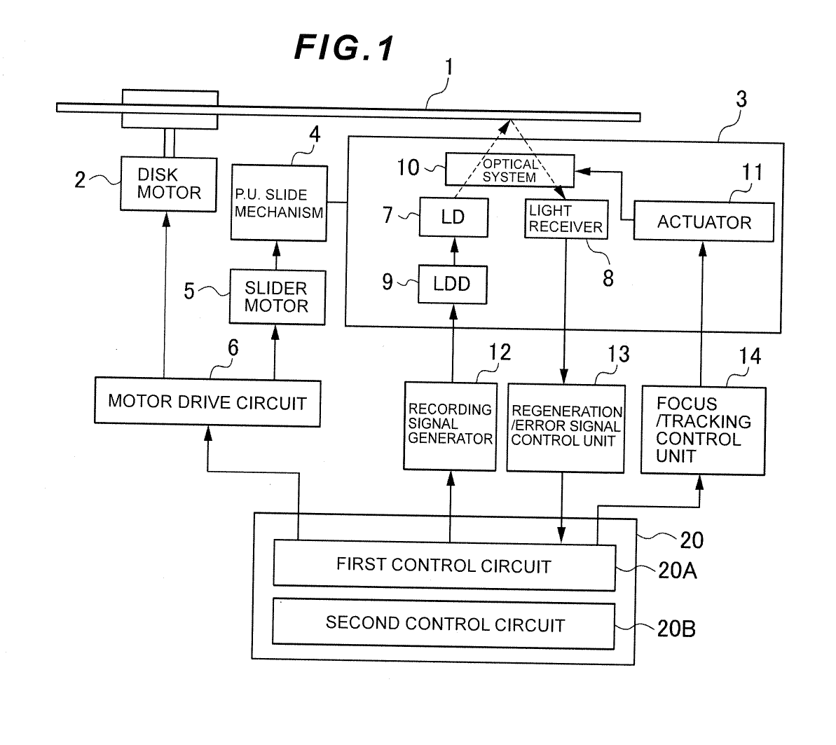

Next, an embodiment of the present invention will be explained. FIG. 1 shows a block configuration of an optical disc device as an example of storage equipment according to the present invention. Referring to FIG. 1, the reference numeral 1 represents an optical disc. A disk motor 2 rotates and drives the optical disc 1. An optical pickup 3 is provided opposite a recording surface of the optical disc. The optical pickup 3 is moved (access movement) by a pickup slide mechanism 4 in a radial direction of the optical disc 1. A slide motor 5 rotates and drives a read screw element in the pickup slide mechanism 4. The disk motor 2 and the slider motor 5 are controlled by a motor drive circuit 6.

The optical pickup 3 includes: a laser diode 7 generating laser light in the optical pickup; a light receiver 8 for receiving the laser light reflected from the recording surface of the optical disc 1; a laser drive circuit 9 for driving the laser diode 7; an optical system 10 having an objective lens and optically processing the laser light which enters, or exits from, the recording surface of the optical disc 1; and an actuator 11 for changing the position or attitude of the optical system 10.

A recording signal recorded on the optical disc 1 is generated by a recording signal generator 12 and a regeneration signal from the light receiver 8 is amplified by a regeneration/error signal processing unit 13 to be an RF signal, a tracking error signal, or a focus error signal. A focus/tracking control unit 14 generates an actuator driving signal.

The reference numeral 20 represents a control unit for the optical disc device and includes a first control circuit 20A and a second control circuit 20B. The first control circuit implements the aforementioned conventional control in the optical disc device. Specifically speaking, the first control circuit generates a servo signal to be supplied to the motor drive circuit 6, generates a signal for controlling the recording signal generator, demodulates a regeneration signal based on a signal from the regeneration/error signal processing unit 13, and generates a focus control signal and a tracking control signal to be supplied to the focus/tracking control unit 14 based on the tracking error signal or the focus error signal.

On the other hand, the second control circuit 20B provides additional control described later to the optical disc device separately from the existing control of the optical disc device.

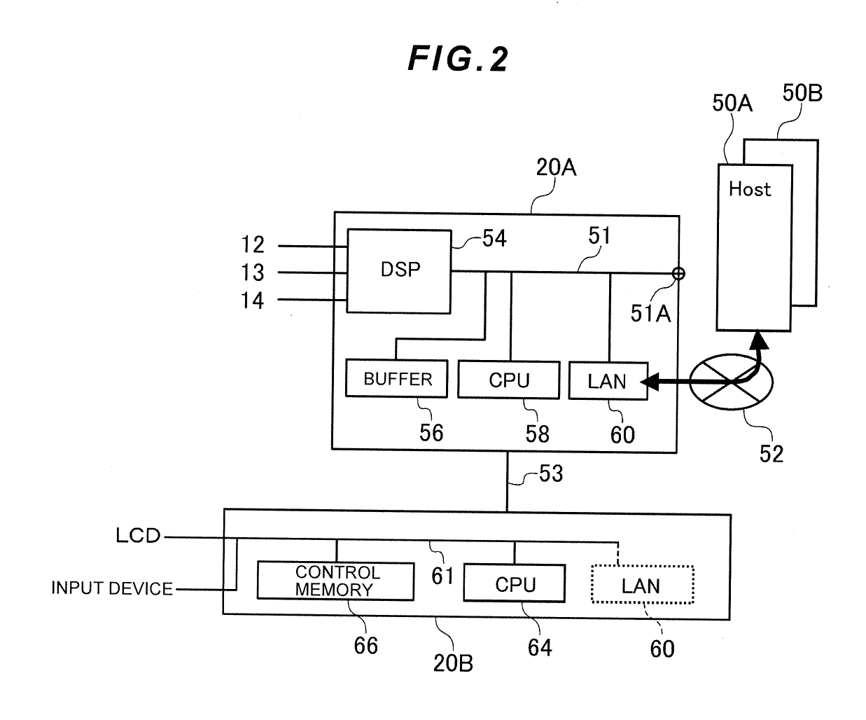

FIG. 2 is a block diagram showing the first control circuit 20A and the second control circuit 20B in detail. The first control circuit includes: a LAN port 60 to be connected to a LAN 52; a DSP (Digital Signal Processor) 54 for executing the aforementioned existing control; a CPU 58 for controlling the DSP; and a buffer 56 for buffering data received/sent between a plurality of host systems 50A, 50B connected to the LAN 52 and the optical disc 1. Examples of the host systems include, for example, besides PCs, video equipment such as televisions, video players, and digital cameras. They are mutually connected via an internal bus 51. Incidentally, the reference numeral 51A represents a port for direct connection with a PC or video equipment.

Incidentally, the DSP 54, the buffer 56, the CPU 58, and the LAN port 60 are realized by using separate hardware resources, but they may be configured so that the buffer 56, the CPU 58, and the LAN port 60 are included in the DSP 54.

The second control circuit 20B is connected with the first control circuit via an external bus 53. The second control circuit is configured so that a CPU 64 for controlling the additional control and a control memory 66, which stores control programs, such as an OS, and control information for the additional control and operates also as a cache memory, are connected to an internal bus 61. Furthermore, a liquid crystal display device (LCD) and an input device are connected to the second control circuit 20B. Incidentally, the second control circuit 20B may be provided with a LAN port.

It should be noted that an SDRAM or a flash memory or SSD can be used as the buffer 56. Also, a flash memory or SSD can be used as the control memory 66.

Furthermore, referring to FIG. 2, the arithmetic processing circuit 58 for the first control circuit 20A and the arithmetic processing circuit 64 for the second control circuit 20B are realized by using separate hardware resources, but either one of the CPUs may operate as a processing circuit for executing the first arithmetic processing and the second arithmetic processing.

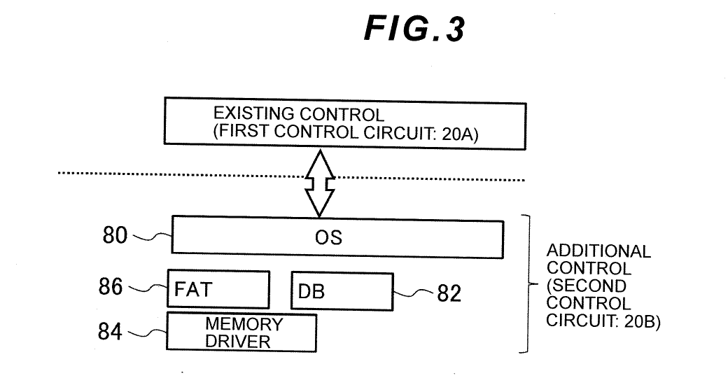

FIG. 3 is a block diagram showing the details of the additional control. The additional control is performed in association with the existing control. For example, along with recording on the optical disc device or regeneration of the optical disc device, the second control circuit executes the additional control on the recording signal or the regeneration signal.

A software configuration for performing the additional control is composed of an OS 80, a file system 86 such as an FAT, a database function 82, and a driver 84 for driving the control memory 66. The OS 80 operates the file system 86, analyzes data recorded on an optical disc and data regenerated from the optical disc, which are cached to the control memory 60, and creates database management information. The database management information is recorded in the control memory 60. The OS 80 and applications realize the database function 82 based on the database management information and data files, such as video files and audio files, recorded in the optical disc.

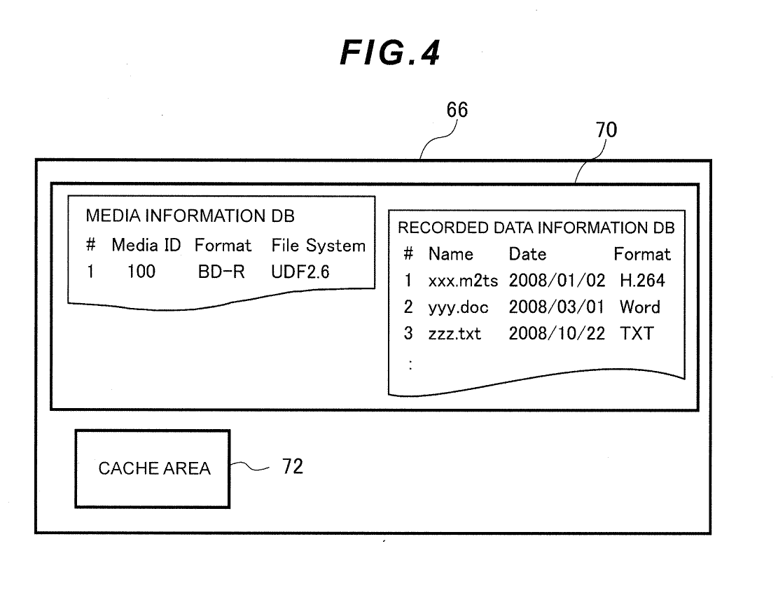

FIG. 4 is a block diagram of the control memory 66. The control memory 66 includes a cache area 72 and an area 70 for storing the database management information. In addition, the control memory 66 also includes an area for storing an OS and application programs for realizing database software and other applications such as an application for analyzing the recorded data and extracting characteristics of the recorded data and an application for reading the database management information and displaying it on the LCD or an external display device.

The database management information is a media information database and a recorded data information database. The media information database is composed of a medium ID, a format, and a file system. When loading the recording medium 1, the CPU 64 for the second control circuit 20B cooperates with the CPU 58 for the first control circuit 20A, obtains the medium ID, the format, and the file system type from the recording medium, and registers them in the media information database.

The recorded data information database includes a data file name, registration date and time for that recorded data file name, and the format type of the data file. The data file name is set by a user via the input device or determined by the CPU 64 when creating the data file.

Since the second control circuit 20B has the file system, the storage equipment according to the present invention can regenerate data files in the recording medium on its own liquid crystal display or regenerate them on an external information device such as a television and regenerate the database function on the liquid crystal display or video equipment by using the database management information and the file system even under the environment where a PC does not exist.

Incidentally, the optical disc(s) has been explained as a recording medium/media; however, the recording medium/media is not limited to this example and the present invention can be applied similarly to known devices or media such as hard disc drives and tape media.

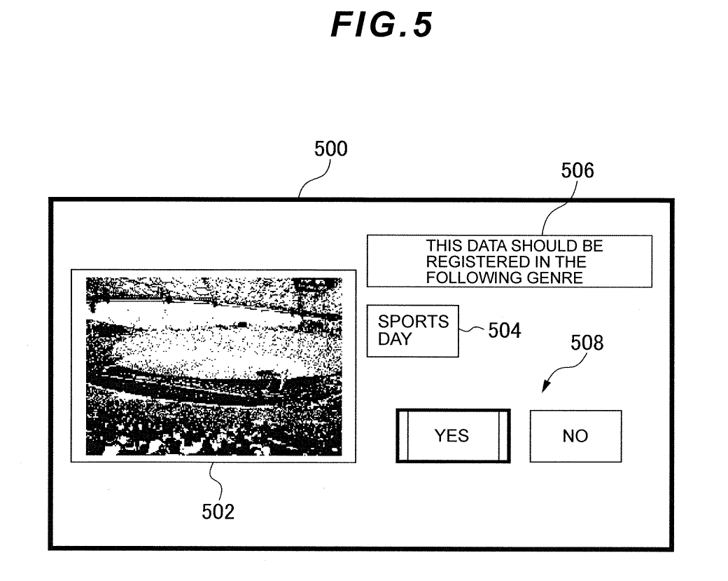

FIG. 5 is a user interface screen displayed on the LCD of the optical disc device. The CPU 64 generates a representative image 502 by having the file system analyze a video file existing in the cache area of the control memory 66, and displays it on the LCD. The CPU 64 activates an image analysis program, executes analysis processing on the video file, and determines characteristics and property (genre) of that image. In an example in FIG. 5, the image analysis program analyzes human bodies and colors and judges that a large number of people are composed of the same color; and, as the judgment result, estimates for the user that the genre of the image is a sports day; and presents indications 504, 506 prompting the user to confirm the estimated result.

In response, the user sends input 508 affirming or denying the judgment result to the CPU 64 by using the input device. The CPU 64 registers the input result, as a flag indicating that, for example, the video file is data of a sports day, in the recorded data information database in the database management information registration area of the control memory.

FIG. 5 shows the GUI which is obtained as a result of analysis of a recorded data file by the storage equipment and prompts the user to confirm the genre, while

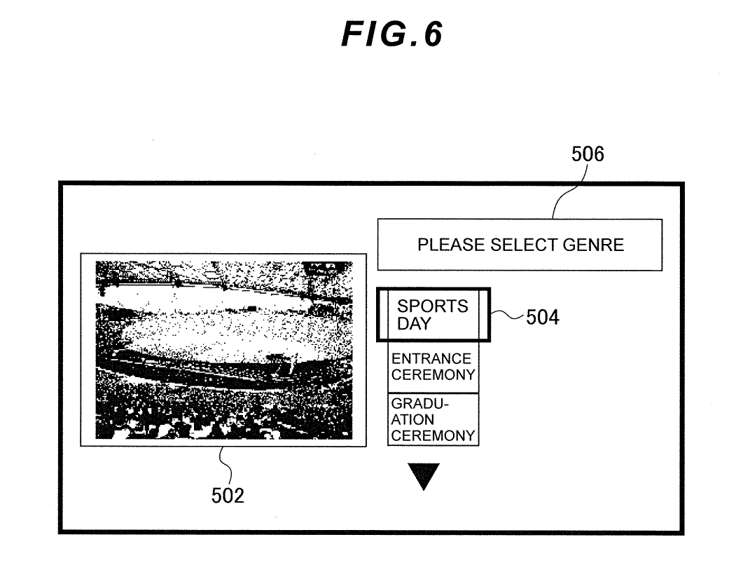

FIG. 6 shows a GUI for analyzing an image which is being viewed on the optical disc, and requesting the user to select the genre of the image. On the other hand,

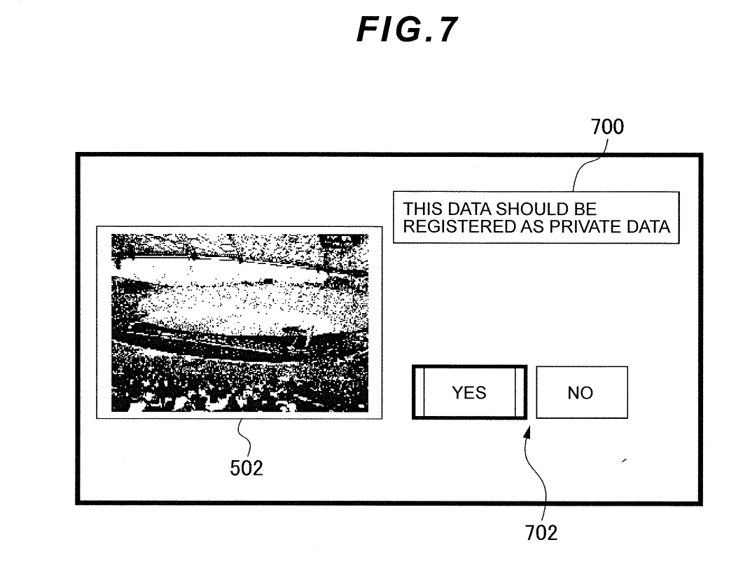

FIG. 7 shows a GUI presenting indications 700, 702 by which the storage equipment prompts the user to distinguish whether the relevant image is private or public. If the user selects that the relevant image is private data, a specific flag is registered in the recorded data information database. Security information such as a specific password can be set to a file to which the above-mentioned flag is set.

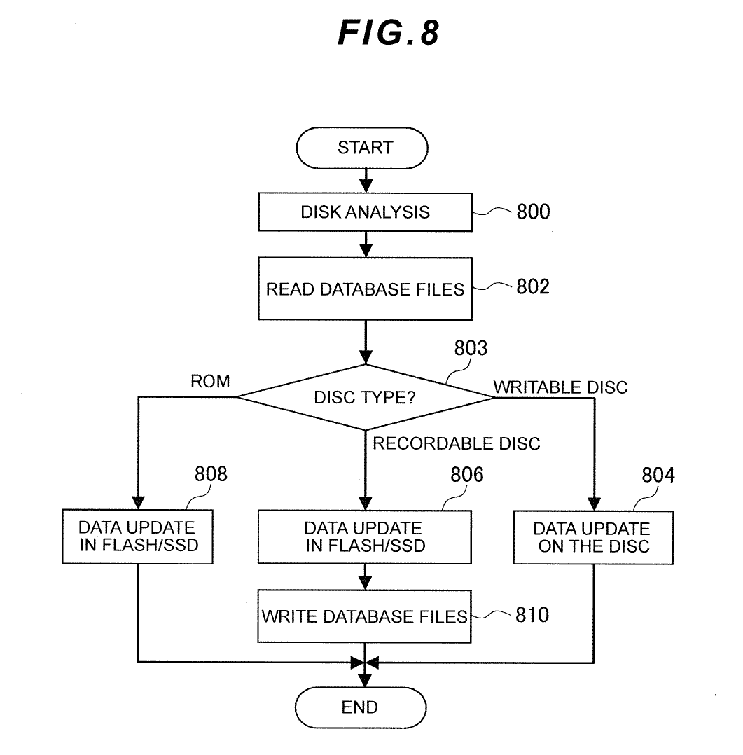

Next, update processing by the CPU 64 on a database will be explained, using FIG. 8. When a recording medium is loaded to the optical disc device, the CPU 64 judges the disc type (800), analyzes a folder structure, and reads database files (802).

If the disc type is an unwritable disc (such as a DVD-ROM or a BD-ROM), the CPU 64 updates the database by constructing the database files in the control memory 60 until the disc is unloaded; and stores the updated final data in the memory or writes all the database files including the updated data back to a new recording medium.

Furthermore, in a case of a write-once read-multiple medium, the data files cannot be updated on that medium. So, after reading the database files, the data is updated in a semiconductor memory 60 and the updated data is written to a recordable medium (803→806→810).

Furthermore, in a case of a writable disc (such as a DVD-RAM or a BD-RE), the processing for updating the database files is executed on the disc (803→804). Needless to say, after reading the database files, the data may be updated in the semiconductor memory 60 and the updated data may be written to the disc as described above, for example, before the disc is unloaded. In this way, with a hybrid system using the recording disc and the semiconductor memory, it is possible to appropriately select the location to store data according to the disc type when updating the database files.

### INDUSTRIAL APPLICABILITY

Since the storage apparatus according to the present invention has its own file system, it can display regenerate, record, and analyze files by itself and display AV information by using external video equipment even when it is not in a PC environment.

### REFERENCE SIGNS LIST

1 optical disc; 2 disk motor; 3 optical pickup; 6 motor drive circuit; 20 control circuit; 20A first control circuit; 20B second control circuit; 54 DSP, first CPU (existing control execution of optical disc device); 60 control memory; 64 second CPU (addition control execution).

1. Storage equipment comprising:
a drive unit for driving a recording medium;
a signal processing unit for sending or receiving a regeneration and/or recording signal to/from the recording medium;
a first control unit having a first arithmetic processing unit for controlling the drive unit and the signal processing unit; and
a second control unit having a control memory and a second arithmetic processing unit;
wherein the control memory includes: an area for storing a file system for data analysis of the recording medium; an area for storing an application program which uses the data; and an area for storing management information used by the application program.

2. The storage equipment according to claim 1, wherein the control memory includes a cache area for temporarily storing the data at the time of regeneration and/or recoding on the recording medium.

3. The storage equipment according to claim 2, wherein the second arithmetic processing unit has the file system analyze the data cached to the cache area and stores a result of the analysis as the management information.

4. The storage equipment according to claim 1, further comprising a port for connection to a network wherein the second arithmetic processing unit applies the file system to data from the host computer connected to the network via the port.

5. The storage equipment according to claim 1, wherein the application program is database software.

6. The storage equipment according to claim 1, wherein the control memory includes a first area for storing database software as the application program, a second area for storing management information of a database recorded on the recording medium, and a third area for temporarily storing the data at the time of data regeneration and/or recording on the recording medium; and
wherein the second arithmetic processing unit has the file system analyze the data temporarily stored in the third area and registers a result of the analysis in the database of the recording medium according to the database software.
